(19) United States
(12) Patent Application Publication
(10) Pub. No.: US 2025/0202098 A1
(43) Pub. Date: Jun. 19, 2025

(54) DIELECTRIC RESONATOR ANTENNA SUBARRAY ON CHIP

(71) Applicant: ROGERS CORPORATION, Chandler, AZ (US)

(72) Inventors: Kristi PANCE, Auburndale, MA (US); Shailesh PANDEY, Woburn, MA (US); Robert Allen KIMBALL, Gilbert, AZ (US); Dirk BAARS, Phoenix, AZ (US); Ingmar Cees Johannes VAN DER LINDEN, Utrecht (NL); Vitali JUDIN, Eggenstein-Leopoldshafen (DE); Eui Kyoon KIM, Acton, MA (US)

(21) Appl. No.: 18/981,046

(22) Filed: Dec. 13, 2024

Related U.S. Application Data
(60) Provisional application No. 63/556,203, filed on Feb. 21, 2024.
(60) Provisional application No. 63/610,669, filed on Dec. 15, 2023.

(51) Int. Cl. H01Q 1/22; H01Q 1/48

(52) U.S. Cl. CPC H01Q 1/2283; H01Q 1/48

(57) ABSTRACT

An electromagnetic, EM, device (1000) configured to be operational at a defined center frequency, f, having a free space wavelength, λ, is disclosed. The EM device includes: an integrated circuit, IC, chip (2000); and, a DRA subarray (3000) integrally arranged with and disposed on the IC chip (2000). The DRA subarray (3000) includes a plurality of DRAs (3100), that can resonate at the same frequency, f, defining a unit cell (3200) having an overall footprint (3300) of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100).

### CROSS REFERENCE TO RELATED APPLICATIONS

This application claims the benefit of U.S. Provisional Application No. 63/556,203, filed on Feb. 21, 2024, and claims the benefit of U.S. Provisional Application No. 63/610,669, filed on Dec. 15, 2023, both of which are incorporated by reference in their entirety herein.

### BACKGROUND

The present disclosure relates generally to an electromagnetic, EM, device, and particularly to a dielectric resonator antenna, DRA, subarray on chip.

While existing EM devices having a DRA may be suitable for their intended purpose, the art relating to such devices would be advanced by a construct as disclosed herein.

### BRIEF SUMMARY

An embodiment includes an EM device as defined by the appended independent claim(s). Further advantageous modifications of the EM device are defined by the appended dependent claims.

An embodiment includes an electromagnetic, EM, device (1000) configured to be operational at a defined center frequency, f, having a free space wavelength, λ. The EM device includes: an integrated circuit, IC, chip (2000); and, a DRA subarray (3000) integrally arranged with and disposed on the IC chip (2000). The DRA subarray (3000) includes a plurality of DRAs (3100), that can resonate at the same frequency, f, defining a unit cell (3200) having an overall footprint (3300) of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100).

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1A depicts a rotated isometric view of a disassembled construct of an EM device having a 3×3 DRA subarray, in accordance with an embodiment;

FIG. 1B depicts a rotated isometric view of an assembled construct of an EM device having a 3×3 DRA subarray similar to that of FIG. 1A, but with an encapsulant, in accordance with an embodiment;

FIGS. 2A, 2B, and 2C, depict various views, top-down rotated isometric, side view, bottom-up rotated isometric, respectively, of a 2×2 DRA silicon subarray within a λ/2 x,y footprint suitable for use at 140 GHz or higher, in accordance with an embodiment;

FIG. 2D depicts a side view of a single DRA of the DRA subarray of FIGS. 2A-2C, in accordance with an embodiment;

FIGS. 3A, 3B, 3C, and 3D, depict various views, top-down rotated isometric, bottom-up rotated isometric, side view, expanded partial view, respectively, of a 3×3 silicon DRA subarray within a λ/2 x,y footprint and having a DRA height H equal to or greater than 0.6 mm and equal to or less than 0.8 mm suitable for use at 140 GHz, where smaller dimensions of a truncated pyramid 3D shape will enable applications greater than 140 GHz, in accordance with an embodiment;

FIGS. 4A and 4B depict various views, transparent top-down rotated isometric, solid top-down rotated isometric, respectively, of an EM device having a 2×2 DRA silicon subarray similar to that of FIGS. 2A-2C, in accordance with an embodiment;

FIGS. 4C and 4D depict various views, transparent top-down rotated isometric, solid top-down rotated isometric, respectively, of an EM device having a 3×3 DRA silicon subarray similar to that of FIGS. 3A-3D, in accordance with an embodiment;

FIG. 5A depicts a rotated isometric view of a disassembled construct of an EM device having a 3×3 DRA subarray similar to that of FIG. 1A, and further depicting a slotted electrical ground disposed on a waveguide chip, in accordance with an embodiment;

FIGS. 5B and 5C depict various views, rotated isometric view, bottom-up rotated isometric view, respectively, of the 3×3 DRA subarray of FIG. 5A with the slotted electrical ground further depicted, in accordance with an embodiment;

FIG. 6 depicts EM performance characteristics of an EM device having a 3×3 DRA subarray, in accordance with an embodiment;

FIG. 7 depicts EM performance characteristics of an EM device having a 2×2 DRA subarray, in accordance with an embodiment;

FIGS. 8A, 8B, and 8C, depict various EM performance characteristics of an EM device having a 3×3 DRA subarray, with certain ones of the DRAs activated (marked by X), in accordance with an embodiment;

FIGS. 9A, 9B, and 9C, depict various EM performance characteristics of the EM device of FIGS. 8A-8C, with certain other ones of the DRAs activated (marked by X), in accordance with an embodiment;

FIGS. 10A and 10B depict various EM performance characteristics of the EM device of FIGS. 8A-8C, with certain other ones of the DRAs activated (marked by X), in accordance with an embodiment;

FIGS. 11A and 11B depict various EM performance characteristics of the EM device of FIGS. 8A-8C, with certain other ones of the DRAs activated (marked by X), in accordance with an embodiment;

FIGS. 12A and 12B depict various EM performance characteristics of the EM device of FIGS. 8A-8C, with certain other ones of the DRAs activated (marked by X), in accordance with an embodiment;

FIGS. 13A and 13B depict a comparison between a prior art EM device (FIG. 13A), and an EM device in accordance with an embodiment (FIG. 13B), illustrating beam steering capability, in accordance with an embodiment;

FIGS. 14A and 14B respectively depict; an EM device having a 2×2 DRA subarray, and associated EM performance characteristics, specifically depicting an associated E-field in non-DRA space, in accordance with an embodiment;

FIGS. 14C and 14D respectively depict; an EM device having a 3×3 DRA subarray, and associated EM performance characteristics, specifically depicting an associated E-field in non-DRA space, in accordance with an embodiment; and

FIGS. 15A and 15B depict a comparison between a prior art antenna-in-package type EM device (FIG. 15A), and an EM device in accordance with an embodiment (FIG. 15B), illustrating an improved compact EM device, in accordance with an embodiment.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

An embodiment, as illustrated and/or described herein by the various figures and accompanying text, provides an EM device in the form of an integrally arranged DRA subarray on a chip. While certain embodiments described and/or illustrated herein depict a certain size DRA subarray (i.e., 2×2 or 3×3 for example), it will be appreciated that the disclosed invention is not so limited and also encompasses other sized arrays of the DRA subarray,

An embodiment, as illustrated and/or described herein by the various figures and accompanying text, provides an EM device having a DRA subarray integrally arranged with and disposed on an IC chip configured and structured to provide an E-Field that propagates within non-DRA space between adjacent ones of the DRAs of the DRA subarray. In an embodiment, the EM device is configured as an antenna subsystem for providing EM beam steering.

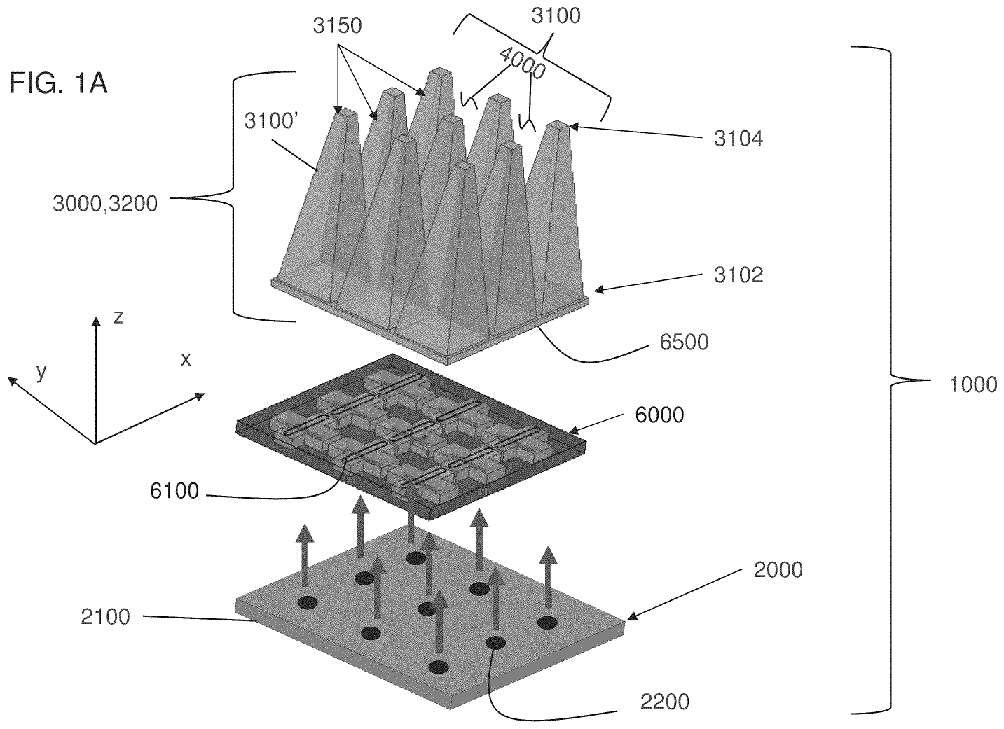

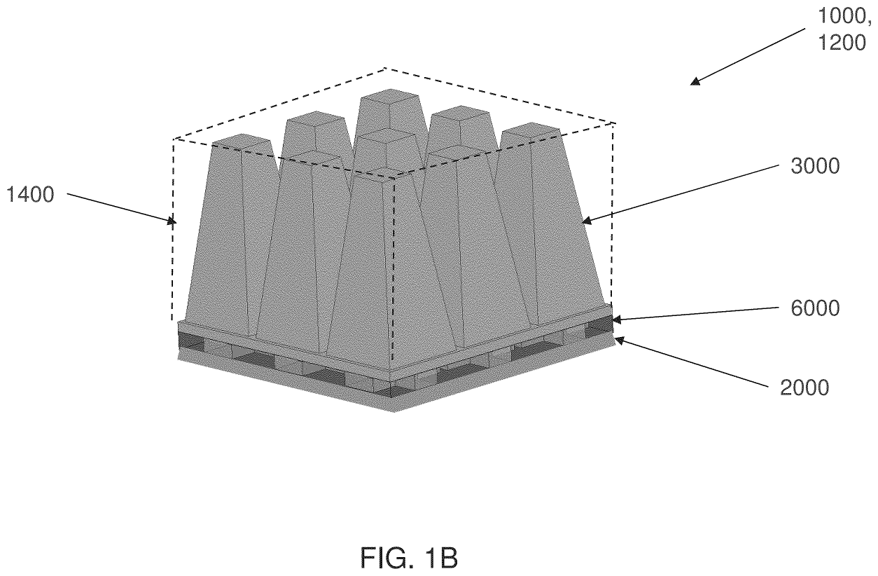

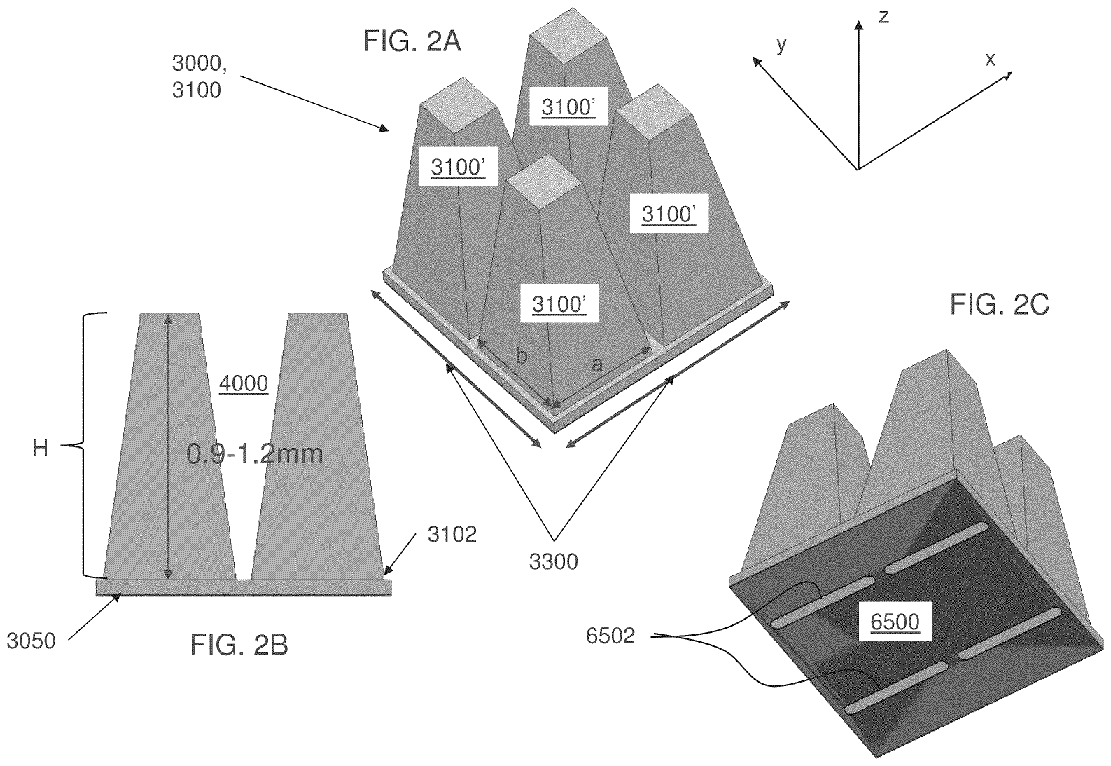

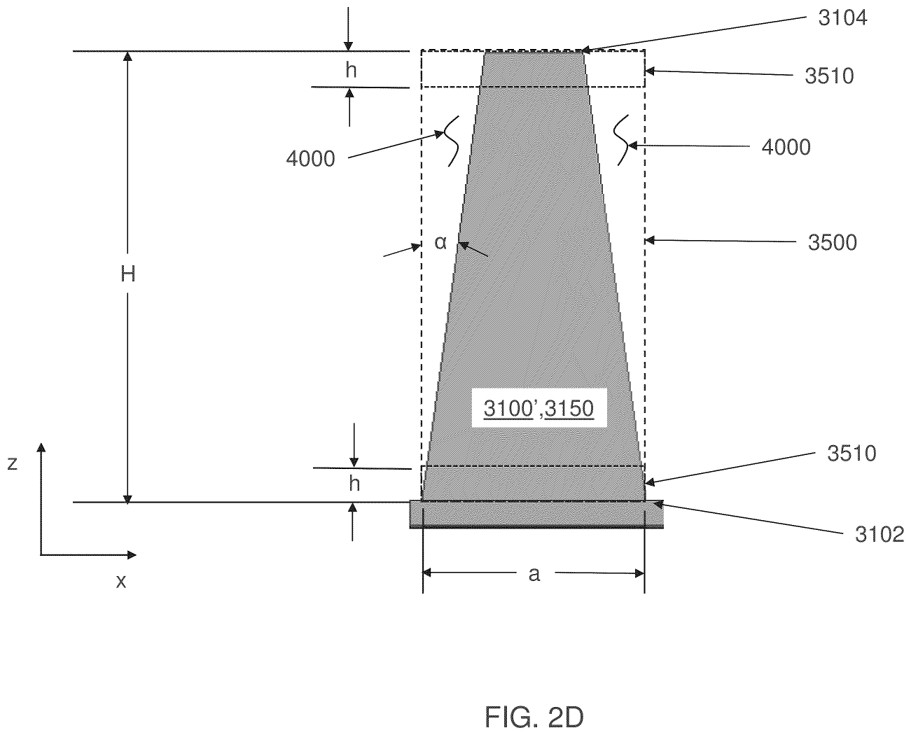

Reference is now made to FIGS. 1A-1B collectively, which depicts an electromagnetic, EM, device (1000) configured to be operational at a defined center frequency, f, having a free space wavelength, λ. In an embodiment, the EM device (1000) includes an integrated circuit, IC, chip (2000), and a DRA subarray (3000) integrally arranged with and disposed on the IC chip (2000). In an embodiment, the DRA subarray (3000) has a plurality of DRAs (3100), which can all resonate at the same frequency, f, and which define a unit cell (3200) having an overall footprint (3300), best seen with reference to FIG. 2A, of equal to or less than λ/2 in both x and y directions of an orthogonal x-y-z coordinate system as observed in a plan view of the EM device (1000), where the z-direction is a direction of vertical extension of each DRA (3100′) of the plurality of DRAs (3100). In an embodiment, f is equal to or greater than 50 GHZ, alternatively equal to or greater than 60 GHz, further alternatively equal to or greater than 77 GHz, and further alternatively equal to or greater than 100 GHz and equal to or less than 1000 GHz. In an embodiment, the DRA subarray (3000) is a monolithic construct. In an embodiment, each DRA (3100′) of the plurality of DRAs (3100) is a solid, non-hollow, construct. In an embodiment, the DRA subarray (3000) is integrally formed with the IC chip (2000). In an embodiment, the IC chip (2000) comprises a substrate (2100) of dielectric material having a first dielectric constant, Dk, and the plurality of DRAs (3100) comprise a dielectric material having a second Dk. In an embodiment, the second Dk is the same as the first Dk. In an embodiment, the first and second Dk materials each comprise any of: Silicon (Si); Germanium (Ge); Silicon-Germanium (SiGe); Silicon-Carbide (SiC); Gallium Nitride (GaN); or, Gallium Arsenide (GaAs). In an embodiment, the dielectric material of the plurality of DRAs (3100) is the same as the dielectric material of the substrate of the IC chip (2000). In an embodiment, each DRA (3100′) of the plurality of DRAs (3100) has a same 3D shape and size (3150). In an embodiment, the 3D shape (3150) of each DRA (3100′) has a proximal end (3102) proximate the IC chip (2000), and an opposing distal end (3104) at a distance from the IC chip (2000), the 3D shape (3150) tapering inward from the proximal end (3102) to the distal end (3104) to form and define non-DRA space (4000) between each adjacent DRA (3100′) of the plurality of DRAs (3100). In an embodiment, a waveguide (6000) is disposed between, and is configured to be in EM communication with, the IC chip (2000) and the DRA subarray (3000). In an embodiment, an encapsulant (1400) (see FIG. 1B) is disposed encapsulating the IC chip (2000), the waveguide (6000), and DRA subarray (3000). In an embodiment, the encapsulant (1400) comprises a dielectric material. In an embodiment, the dielectric material of the encapsulant (1400) has a Dk value greater than 1 and equal to or less than 5, alternatively equal to or greater than 2 and equal to or less than 4. In an embodiment, the EM device (1000), with or without the encapsulant (1400) forms a unitary DRA-subarray-on-chip construct (1200). In an embodiment, the waveguide (6000) is formed from a silicon substrate. In an embodiment, the IC chip (2000) includes a plurality of contacts (2200) arranged in an array in a one-to-one correspondence with strip line signal feeds (6100) of the waveguide (6000).

With reference now to FIGS. 2A-2D collectively, in an embodiment, the inwardly tapered 3D shape (3150) of each DRA (3100′) has a first effective Dk value at the proximal end (3102), and a second effective Dk value at the distal end (3104) that is less than the first effective Dk value, wherein the respective effective Dk value is defined by the Dk value associated with incremental and uniform 3D cross sectional slices (3510) in the z-direction of a non-tapered envelope (3500) that bounds both the 3D shape (3150) of the respective DRA (3100′) and the associated portion of non-DRA space (4000) about the respective DRA (3100′), and wherein a thickness h of the 3D cross sectional slices (3510) in the z-direction is equal to or less than 10% of an overall height H of the respective DRA (3100′) in the z-direction. While only a lower slice (3510) and an upper slice (3510) is depicted in FIG. 2D, it will be appreciated that this is only for clarity of illustration, and that for analysis purposes the number of slices would be consecutive and adjacent each other from the lower to the upper slice (3510). In an embodiment, the first effective Dk value is equal to or greater than 12 and equal to or less than 16, and the second effective Dk value is equal to or greater than 1 and equal to or less than 5. In an embodiment, the inwardly tapered 3D shape (3150) has a taper angle a of equal to or greater than 20-degrees and equal to or less than 35-degrees; alternatively, equal to or greater than 25-degrees and equal to or less than 30-degrees. In an embodiment, the 3D shape (3150) of each DRA (3100′) has overall outside footprint dimensions, a and b, at the proximal end (3102), and an overall height, H, from the proximal end (3102) to the distal end (3104), wherein H is greater than a, or H is greater than b, alternatively, H is greater than a, and H is greater than b. In an embodiment, the x, y overall footprint (3300) is 1 mm×1 mm for 140 GHz applications. In an embodiment, the overall footprint (3300) can be made smaller for applications greater than 140 GHz. In an embodiment, H is equal to or greater than two times a, or H is equal to or greater than two times b, alternatively, H is equal to or greater than two times a, and H is equal to or greater than two times b. In an embodiment, H is equal to or greater than 0.6 mm and equal to or less than 0.8 mm, and is suitable for use at 140 GHz. In an embodiment, the DRA subarray (3000), and more particularly an integrally formed base (3050) at a proximal end (3102) of the plurality of DRAs (3100) has a ground plane (6500) disposed between, and configured to be in EM communication with, the waveguide (6000) and the DRA subarray (3000), the ground plane (6500) having a plurality of slotted apertures (6502) (four illustrated, but only two denoted as representational) arranged in a one-to-one correspondence with a respective one of the plurality of DRAs (3100).

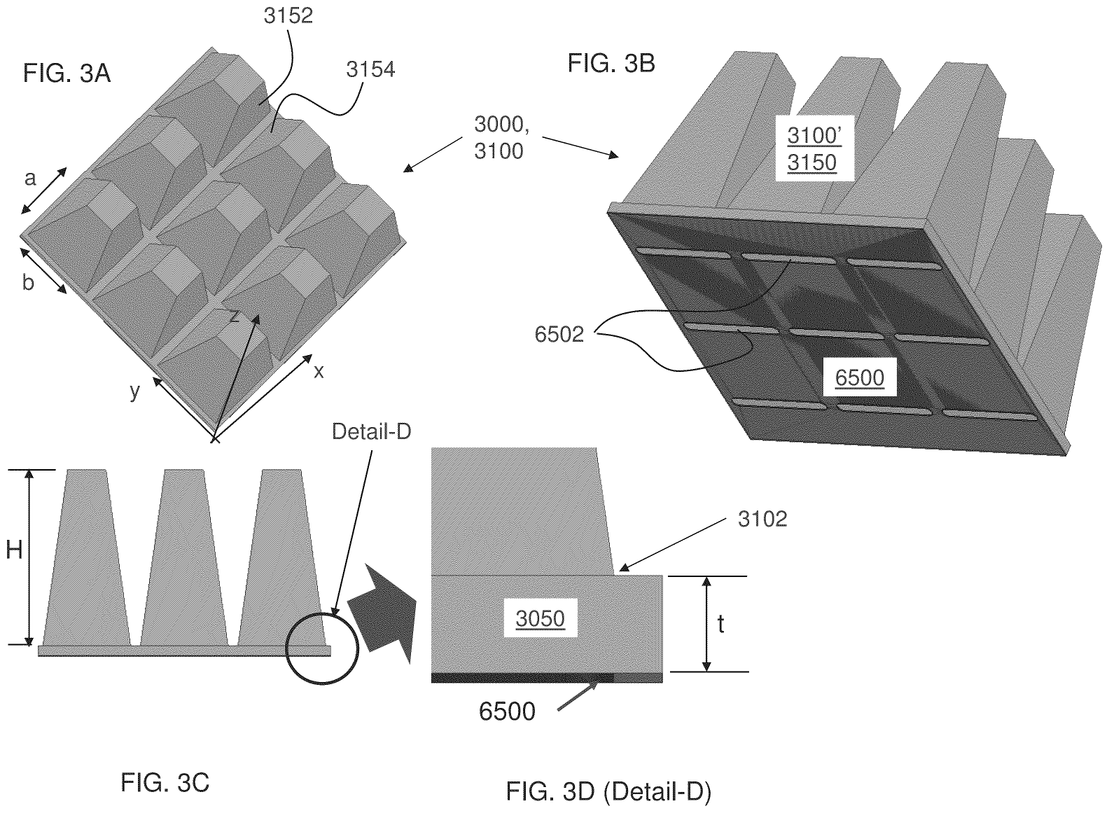

With reference now to FIGS. 3A-3D in combination with FIG. 1A, in an embodiment, the 3D shape (3150) of each DRA (3100′) has a faceted surface (3152) that faces another faceted surface (3154) of an adjacent one of the plurality of DRAs (3100). The shape and tapered spacing of the faceted surfaces relative to each other serve to define the non-DRA space (4000) in which the E-field, when present, is guided and propagates. In an embodiment, the DRA subarray (3000), and more particularly an integrally formed base (3050) at a proximal end (3102) of the plurality of DRAs (3100) has a ground plane (6500) disposed between, and configured to be in EM communication with, the waveguide (6000) and the DRA subarray (3000), the ground plane (6500) having a plurality of slotted apertures (6502) (nine illustrated, but only two denoted as representational) arranged in a one-to-one correspondence with a respective one of the plurality of DRAs (3100).

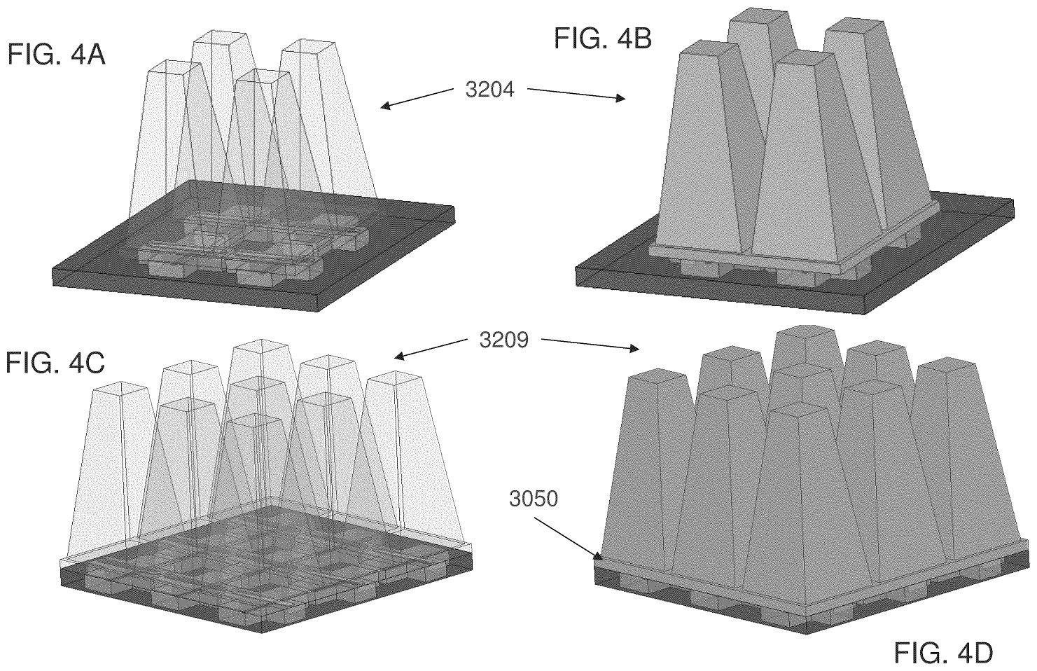

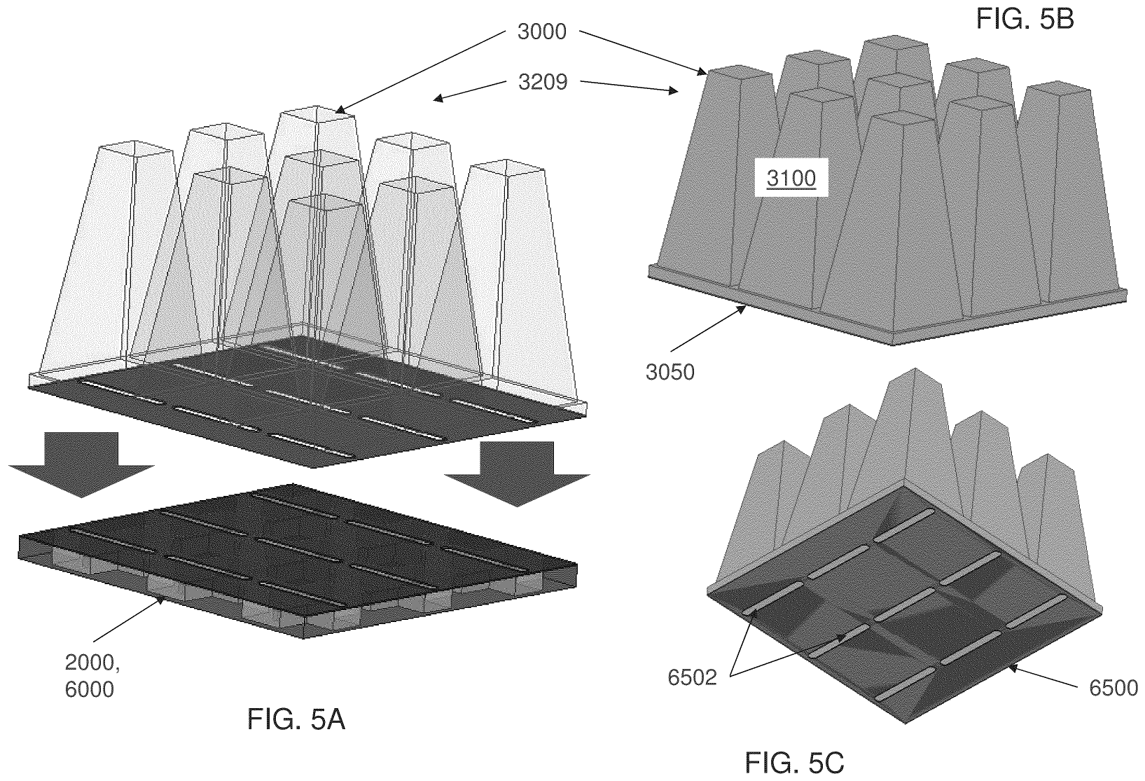

With reference now to FIGS. 4A-4D and 5A-5C, in combination with 3A-3D, in an embodiment, and as illustrated herein, the unit cell (3200) of a given DRA subarray (3000) is at least a 2×2 array (3204) of the plurality of DRAs (3100). Alternatively, the unit cell (3200) is at least a 3×3 array (3209) of the plurality of DRAs (3100). While certain sized arrays of the plurality of DRAs (3100) are illustrated herein, it will be appreciated that the scope of disclosure herein of such EM devices (1000) is not so limited, and that any size array falling within the ambit of the appended claims is contemplated and considered to be inherently disclosed herein. In an embodiment, the DRA subarray (3000), whether it comprises a 2×2 array (3204) or a 3×3 array (3209) or any other sized array falling within an ambit of the appended claims, is a monolithic construct that includes the integrally formed base 3050 having a thickness t that is relatively thin as compared to H to form a connected-DRA subarray (also herein referred to by reference numeral 3000) (best seen with reference to FIG. 3D). In an embodiment, t is greater than zero and equal to or less than H/5, alternatively t is greater than zero and equal to or less than H/10, further alternatively t is greater than zero and equal to or less than H/15. In an embodiment, the integrally formed unitary construct of the plurality of DRAs (3100) and the base (3050) is herein referred to as connected-DRAs (3000).

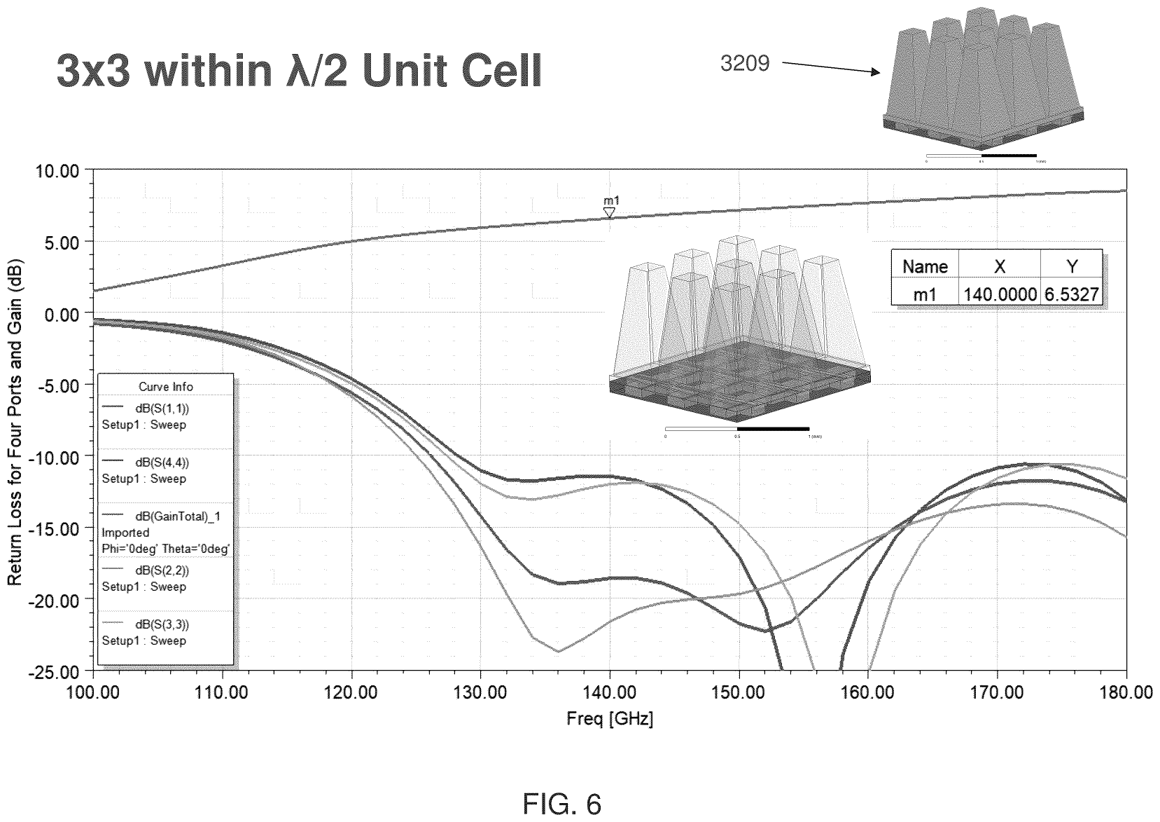

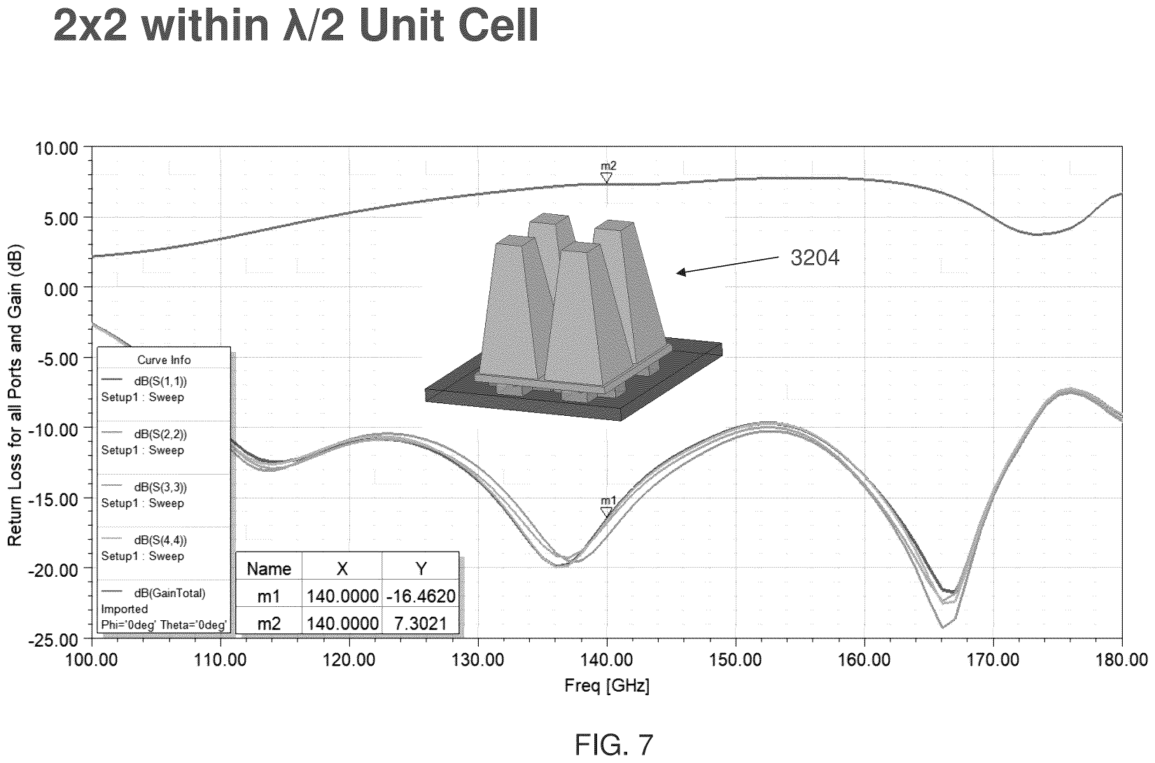

FIGS. 6 and 7 respectively depict analytically modeled performance characteristics of 3×3 array (3209) and a 2×2 array (3204), within a λ/2 unit cell footprint (3300).

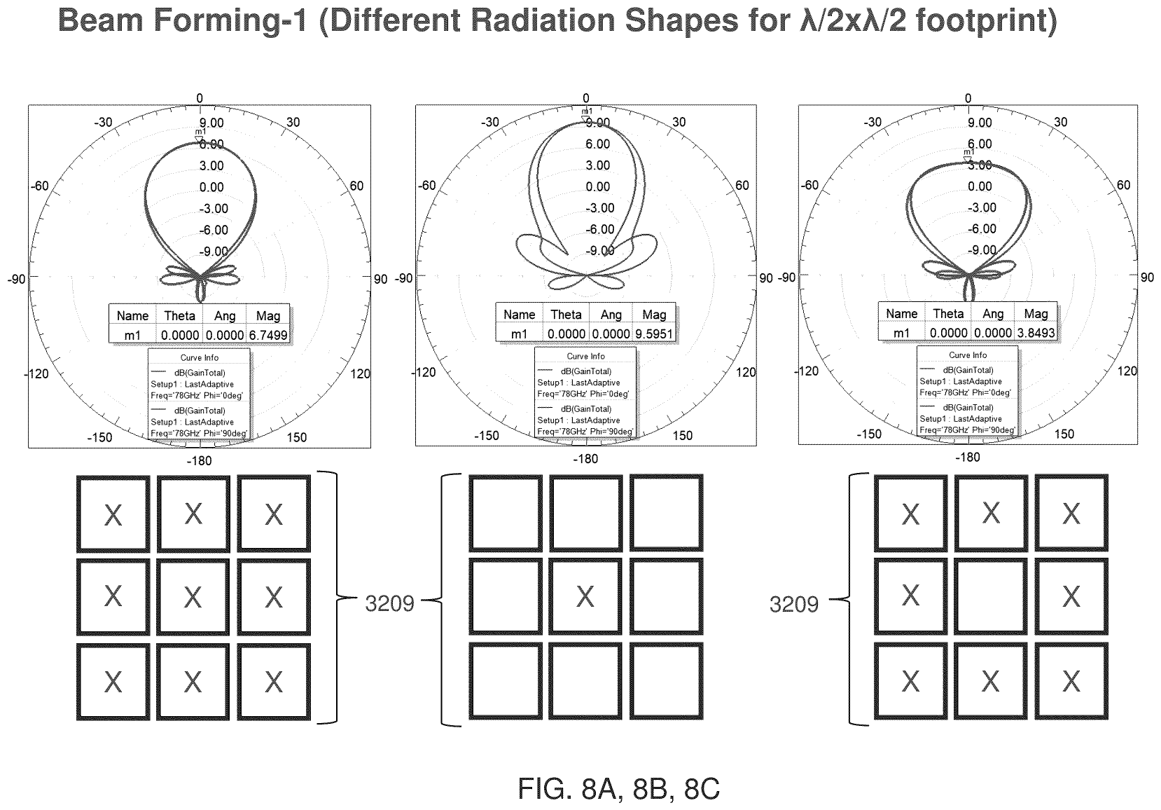

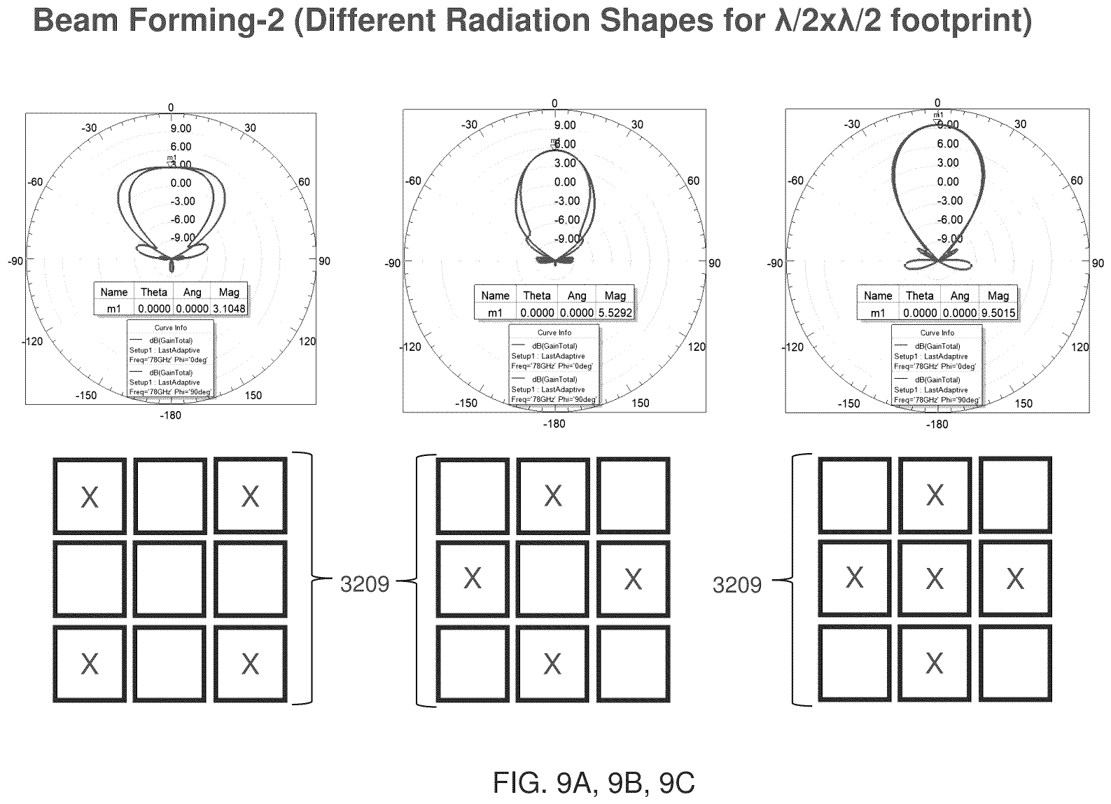

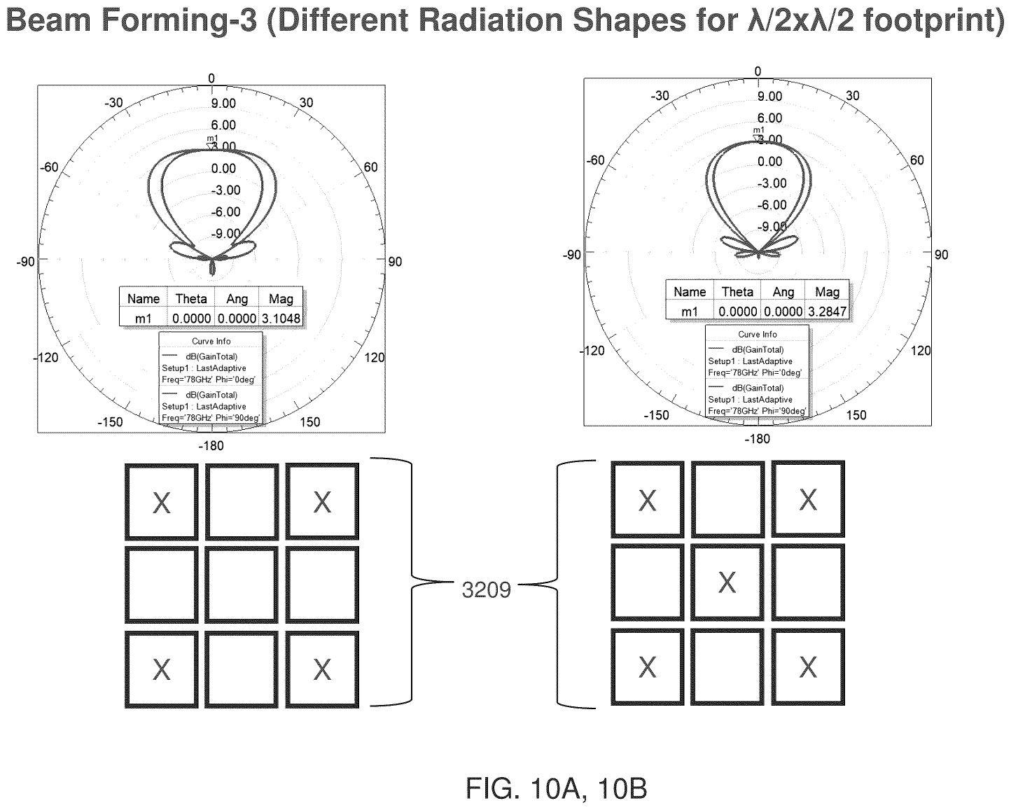

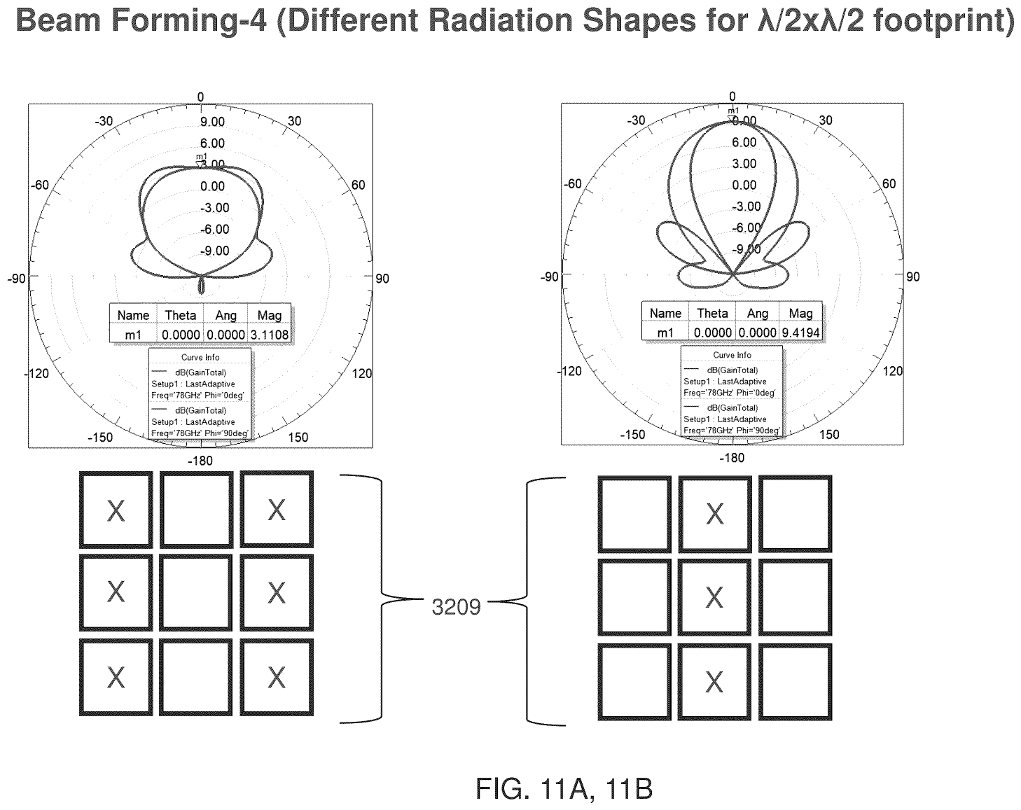

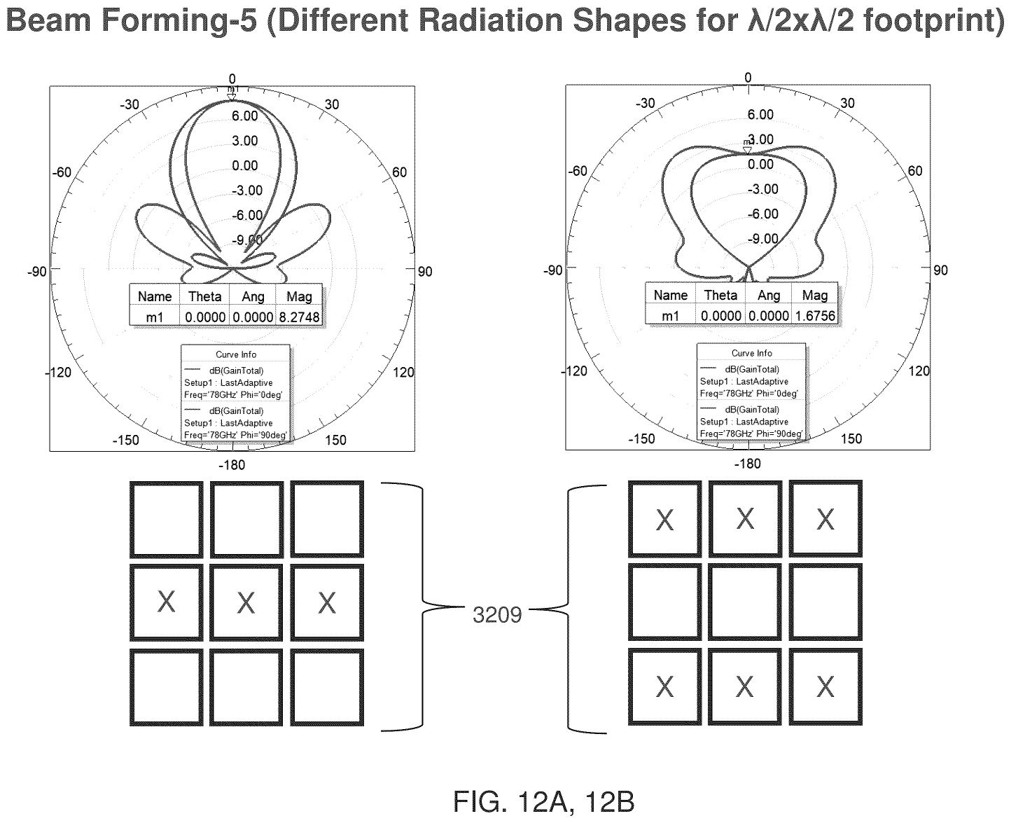

Reference is now made to FIGS. 8A-8C, 9A-9C, 10A-10B, 11A-11B, and 12A-12B, collectively, which depict a variety of arrangements whereby excitation (labelled “X”) of individual ones of a plurality of DRAs (3100) of a 3×3 array (3209) is performed, where in an embodiment the IC chip (2000) of the EM device (1000) is capable of and is configured to activate (labelled “X”) or deactivate, or terminate in 50-Ohm loads. (blank box) certain ones of the plurality of DRAs (3100) in the DRA subarray (3000), so as to effect beam shaping or beam steering of EM radiation emitted from the EM device (1000). In effect, the structure acts as a resonator-lens-in-one. The analytically modeled resulting E-field and H-field radiation characteristics are depicted in FIGS. 8A-8C, 9A-9C, 10A-10B, 11A-11B, and 12A-12B, for the different excitation scenarios.

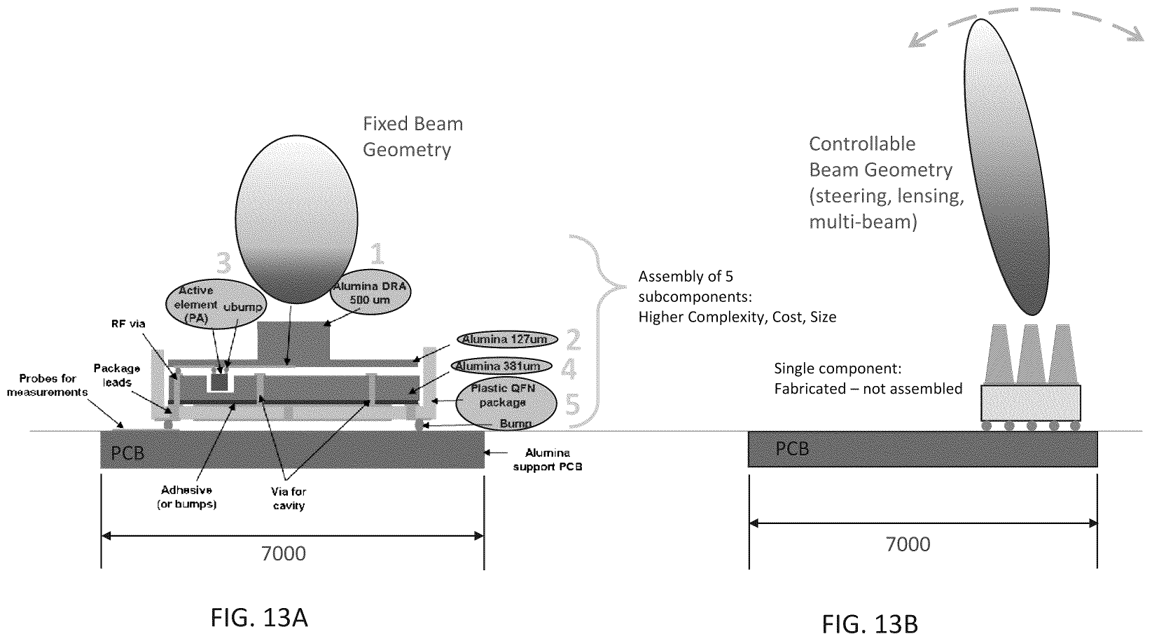

FIGS. 13A and 13B depict a comparison between an existing DRA solution (FIG. 13A) involving a DRA-in-Package arrangement, and an approach as disclosed herein (FIG. 13B) involving a monolithic/integrated DRA-on-Chip arrangement, where both arrangements are arranged on a PCB having a same footprint (7000), representative of x and y dimensions. In FIG. 13A, the DRA-in-Package arrangement is depicted having a complex arrangement of multiple subcomponents in an assembly to occupies footprint (7000) on a given PCB, which provides a fixed beam geometry. In comparison and as depicted in FIG. 13B, the DRA-on-Chip arrangement is depicted having a compact arrangement of a unitary DRA-subarray-on-chip construct that occupies about ¼ of the same PCB footprint (7000) (½ in the x-dimension, and ½ in the y-dimension) that the DRA-in-Package arrangement of FIG. 13A occupies, and further provides for beam steering, as discussed herein above.

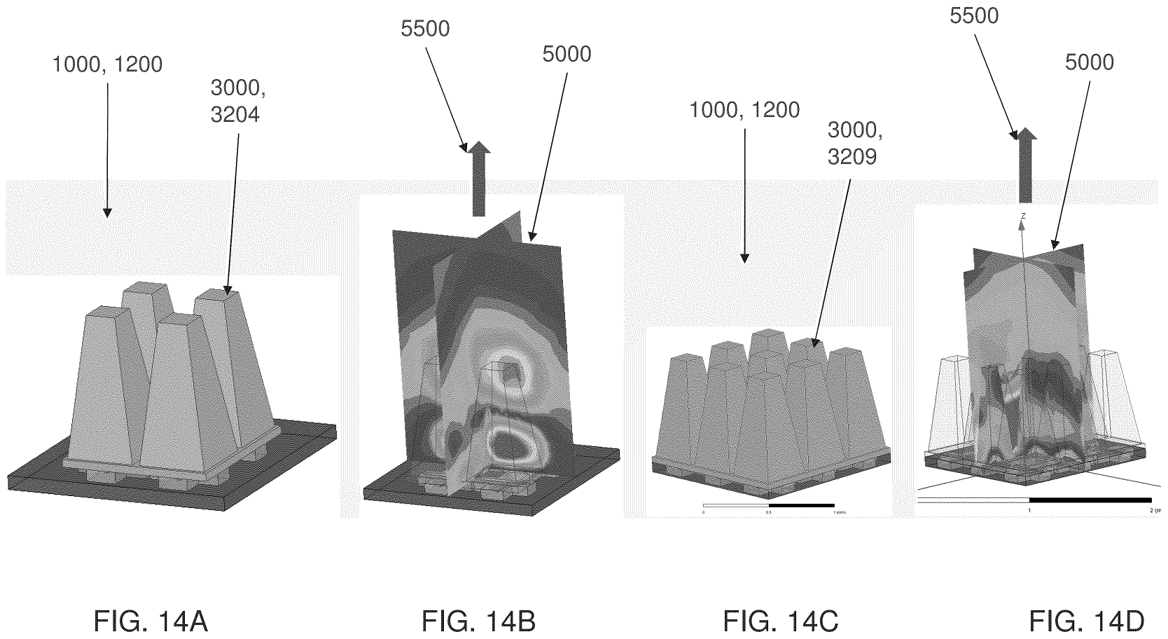

With reference to FIGS. 14A-14D in combination with at least FIG. 1A, the DRA subarray (3000), 2×2 array (3204) or 3×3 array (3209) for example, is structurally configured to guide an E-field (5000), when present in the EM device (1000), in the non-DRA space (4000) (see FIG. 1A for example) between each DRA (3100′) of the plurality of DRAs (3100). A direction of EM radiation (5500), when present in the EM device (1000), is directed from the proximal end (3102) of each DRA (3100′) to the distal end (3104) of each DRA (3100′). In such an embodiment, the high Dk of each DRA (3100′) acts like a waveguide, with the energy of the E-field (5000) being concentrated in the non-DRA space (4000). FIGS. 14B and 154D depict analytical modeling results illustrating the propagation of a generated E-field (5000) that is guided in the non-DRA space (4000) between the tapered 3D shapes (3150) of the plurality of DRAs (3100) of a 2×2 array (3204) and a 3×3 array (3209), respectively.

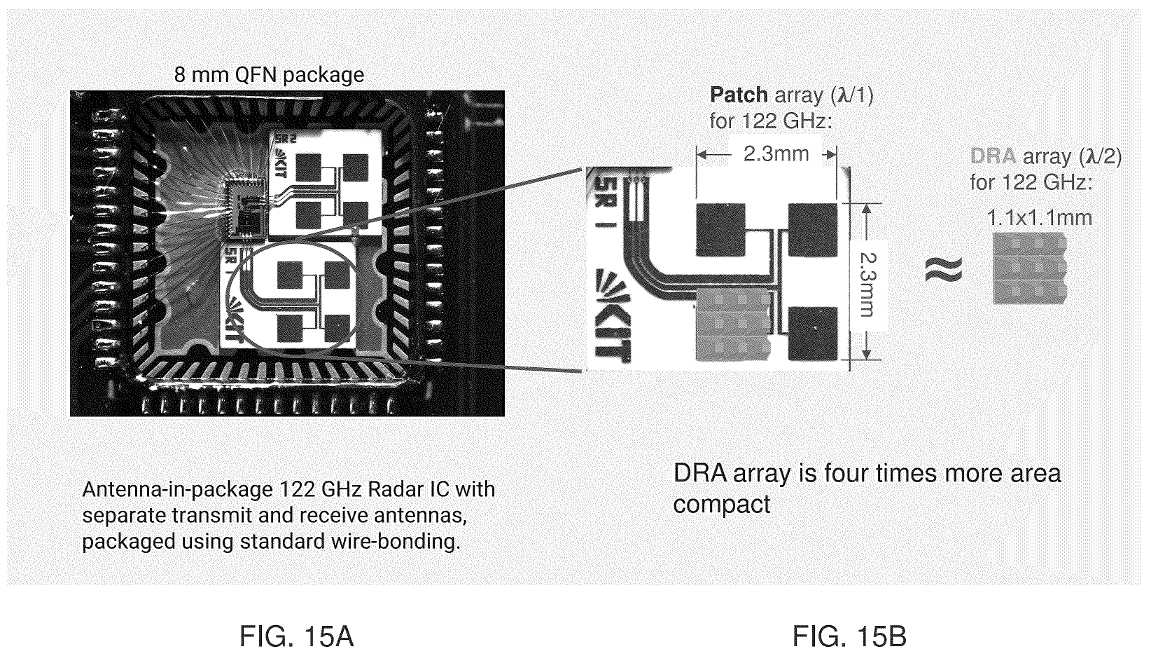

FIG. 15A depicts a prior art antenna-in-package type EM device using standard wire bonding connections, which in the embodiment depicted is a 122 GHz Radar IC with separate transmit and receive antennas, with each antenna having a 2×2 patch array with an overall footprint of λ×λ (2.3 mm×2.3 mm at 122 GHz). In comparison, FIG. 15B depicts a single DRA array as disclosed herein capable of occupying just ¼ of the footprint of the prior art antenna-in-package type EM device of FIG. 15A, and having a footprint of λ/2×λ/2 (1.1 mm×1.1 mm) while still being suitable for operation at 122 GHz as a direct replacement for the prior art antenna-in-package type EM device of FIG. 15A. Accordingly, it will be appreciated that a substantial improvement in the art is realized by a device as disclosed herein that is considerably more compact than prior art antenna-in-package type EM devices.

Another advantage of the EM device (1000) as disclosed herein, is that for such an EM device (1000) it is contemplated to be manufacturable using existing semi-conductor manufacturing methods.

As a first example, an EM device (1000) as disclosed herein may be fabricated by the process of any one of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

As a second example, a fabrication of an EM device (1000) as disclosed herein may be produced by the process of any one of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

As a third example, a method of fabricating an EM device (1000) as disclosed herein may include any one of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

As used herein, the term “unitary,” “monolith,” or “monolithic,” for example, a unitary component or a monolith or monolithic structure, refers to a three-dimensional construction, e.g., one body, that can be formed from portions that can have substantially identical or identical compositions. A monolith can be made of a single, continuous material, e.g., thermoplastic material, and can be manufactured using various techniques, including injection molding, compression molding, extrusion, 3D printing, and additive manufacturing. Accordingly, a unitary or monolithic component differs from a laminate or assembly of differing constituents, which includes an interface between differing constituents thereof. A unitary component can be integrally formed, for example, integrally molded in a single mold. Similarly, as used herein, portions can be “integrally formed,” or one portion can be “integrally formed” with a different portion, resulting in a unitary component differing from a laminate or assembly of differing constituents, which includes an interface between differing constituents thereof.

While embodiments described and/or illustrated herein depict DRAs of a DRA subarray having a particular cross-section profile (x-y, x-z, or y-z), it will be appreciated that such profiles may be modified without departing from a scope of the invention. As such, any profile that falls within the ambit of the disclosure herein, and is suitable for a purpose disclosed herein, is contemplated and considered to be complementary to the embodiments disclosed herein.

While the following example embodiments are individually presented, it will be appreciated from a complete reading of all of the embodiments described herein below that similarities may exist among the individual embodiments that would enable some cross over of features and/or processes. As such, combinations of any of such individual features and/or processes may be employed in accordance with an embodiment, whether or not such combination is explicitly illustrated, while remaining consistent with the disclosure herein. The several figures associated with one or more of the following example embodiments depict an orthogonal set of x-y-z axes that provide a frame of reference for the structural relationship of corresponding features with respect to each other, where an x-y plane coincides with a plan view, and an x-z or y-z plane coincides with an elevation view, of the corresponding embodiments.

As used herein, the phrase “having a Dk material other than air” necessarily includes a Dk material that is not air, but may also include air, which includes a foam. As used herein, the phrase “comprising air” necessarily includes air, but also does not preclude a Dk material that is not air, which includes a foam. Also, the term “air” may more generally be referred to and viewed as being a gas having a dielectric constant that is suitable for a purpose disclosed herein.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

With respect to the foregoing and the several figures of FIGS. 1A-15B, it will be appreciated that various aspects of an embodiment are disclosed herein, which are in accordance with, but not limited to, at least the following aspects and/or combinations of aspects.

Aspect 1 (see FIG. 1A for example): An electromagnetic, EM, device (1000) configured to be operational at a defined center frequency, f, having a free space wavelength, λ, the EM device (1000) comprising: an integrated circuit, IC, chip (2000); a DRA subarray (3000) integrally arranged with and disposed on the IC chip (2000); the DRA subarray (3000) comprising a plurality of DRAs (3100), that can resonate at the same frequency, f, defining a unit cell (3200) having an overall footprint (3300) of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100).

Aspect 2: The EM device (1000) of Aspect 1, wherein: f is equal to or greater than 50 GHz, alternatively equal to or greater than 60 GHz, further alternatively equal to or greater than 77 GHz, further alternatively equal to or greater than 100 GHz, and equal to or less than 1000 GHz.

Aspect 3: The EM device (1000) of any one of Aspects 1 to 2, wherein: the DRA subarray (3000) is a monolithic construct.

Aspect 4: The EM device (1000) of any one of Aspects 1 to 3, wherein: each DRA (3100′) of the plurality of DRAs (3100) is a solid, non-hollow, construct.

Aspect 5 (see FIG. 1B for example): The EM device (1000) of any one of Aspects 1 to 4, wherein: the DRA subarray (3000) is integrally formed with the IC chip (2000).

Aspect 6: The EM device (1000) of any one of Aspects 1 to 5, wherein: the IC chip (2000) comprises a substrate (2100) of dielectric material having a first dielectric constant, Dk, and the plurality of DRAs (3100) comprise a dielectric material having a second Dk.

Aspect 7: The EM device (1000) of Aspect 6, wherein: the second Dk is the same as the first Dk.

Aspect 8: The EM device (1000) of any one of Aspects 6 to 7, wherein: the first and second Dk materials each comprise any of: Silicon (Si); Germanium (Ge); Silicon-Germanium (SiGe); Silicon-Carbide (SiC); Gallium Nitride (GaN); or, Gallium Arsenide (GaAs).

Aspect 9: The EM device (1000) of any one of Aspects 6 to 8, wherein: the dielectric material of the plurality of DRAs (3100) is the same as the dielectric material of the substrate of the IC chip (2000).

Aspect 10: The EM device (1000) of any one of Aspects 1 to 9, wherein: each DRA (3100′) of the plurality of DRAs (3100) has a same 3D shape and size (3150).

Aspect 11 (see FIGS. 1A and 2D for example): The EM device (1000) of Aspect 10, wherein: the 3D shape (3150) of each DRA (3100′) has a proximal end (3102) proximate the IC chip (2000), and an opposing distal end (3104) at a distance from the IC chip (2000), the 3D shape (3150) tapering inward from the proximal end (3102) to the distal end (3104) to form and define non-DRA space (4000) between each adjacent DRA (3100′) of the plurality of DRAs (3100).

Aspect 12: The EM device (1000) of Aspect 11, wherein: the inwardly tapered 3D shape (3150) has a first effective Dk value at the proximal end (3102), and a second effective Dk value at the distal end (3104) that is less than the first effective Dk value; wherein the respective effective Dk value is defined by the Dk value associated with incremental and uniform 3D cross sectional slices (3510) in the z-direction of a non-tapered envelope (3500) that bounds both the 3D shape (3150) of the respective DRA (3100′) and the associated portion of non-DRA space (4000) about the respective DRA (3100′); wherein a thickness h of the 3D cross sectional slices (3510) in the z-direction is equal to or less than 10% of an overall height H of the respective DRA (3100′) in the z-direction.

Aspect 13: The EM device (1000) of Aspect 12, wherein: the first effective Dk value is equal to or greater than 12 and equal to or less than 16, and the second effective Dk value is equal to or greater than 1 and equal to or less than 5.

Aspect 14: The EM device (1000) of any one of Aspects 11 to 13, wherein: the inwardly tapered 3D shape (3150) has a taper angle α of equal to or greater than 20-degrees and equal to or less than 35-degrees; alternatively, equal to or greater than 25-degrees and equal to or less than 30-degrees.

Aspect 15: The EM device (1000) of any one of Aspects 11 to 14, wherein: the 3D shape (3150) of each DRA (3100′) has overall outside footprint dimensions, a and b, at the proximal end (3102), and an overall height, H, from the proximal end (3102) to the distal end (3104); and, H is greater than a, or H is greater than b; alternatively, H is greater than a, and H is greater than b.

Aspect 16: The EM device (1000) of Aspect 15, wherein: H is equal to or greater than two times a, or H is equal to or greater than two times b; alternatively, H is equal to or greater than two times a, and H is equal to or greater than two times b.

Aspect 17 (see FIG. 3A for example): The EM device (1000) of any one of Aspects 11 to 16, wherein: the 3D shape (3150) of each DRA (3100′) has a faceted surface (3152) that faces another faceted surface (3154) of an adjacent one of the plurality of DRAs (3100).

Aspect 18 (see FIGS. 1A and 14A-14D for example): The EM device (1000) of any one of Aspects 11 to 17, wherein: the DRA subarray (3000) is structurally configured to guide an E-field (5000), when present in the EM device (1000), in the non-DRA space (4000) between each DRA (3100′) of the plurality of DRAs (3100).

Aspect 19: The EM device (1000) of any one of Aspects 11 to 18, wherein: a direction of EM radiation (5500), when present in the EM device (1000), is directed from the proximal end (3102) of each DRA (3100′) to the distal end (3104) of each DRA (3100′).

Aspect 20: The EM device (1000) of any one of Aspects 1 to 19, wherein: the unit cell (3200) is at least a 2×2 array (3204) of the plurality of DRAs (3100); alternatively, the unit cell (3200) is at least a 3×3 array (3209) of the plurality of DRAs (3100).

Aspect 21: The EM device (1000) of any one of Aspects 1 to 20, further comprising: a waveguide (6000) disposed between, and configured to be in EM communication with, the IC chip (2000) and the DRA subarray (3000).

Aspect 22 (see FIGS. 2C, 3B, 5A-5C, for example): The EM device (1000) of Aspect 21, further comprising: a ground plane (6500) disposed between, and configured to be in EM communication with, the waveguide (6000) and the DRA subarray (3000), the ground plane (6500) having a plurality of slotted apertures (6502) arranged in a one-to-one correspondence with a respective one of the plurality of DRAs (3100).

Aspect 23 (see FIGS. 8A-12B, and 13B, for example): The EM device (1000) of any one of Aspects 1 to 22, wherein: the IC chip (2000) is capable of being configured to activate or deactivate, or terminate in 50-Ohm loads, certain ones of the plurality of DRAs (3100) in the DRA subarray (3000) so as to effect beam shaping or beam steering within the EM device (1000).

Aspect 24: The EM device (1000) of any one of Aspects 1 to 23, wherein: the EM device (1000) forms a unitary DRA-subarray-on-chip construct (1200).

Aspect 25 (see FIG. 1B for example): The EM device (1000) of any one of Aspects 21 to 22, further comprising: an encapsulant (1400) disposed encapsulating the IC chip (2000), the waveguide (6000), and DRA subarray (3000).

Aspect 26: The EM device (1000) of Aspect 25, wherein: the encapsulant (1400) comprises a dielectric material.

Aspect 27: The EM device (1000) of Aspect 26, wherein: the dielectric material of the encapsulant (1400) has a Dk value greater than 1 and equal to or less than 5, alternatively equal to or greater than 2 and equal to or less than 4.

Aspect 28: An electromagnetic, EM, device (1000) according to any one of claims 1 to 27, wherein the device is fabricated by the process of any one of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

Aspect 29: A fabrication of an electromagnetic, EM, device (1000) according to any one of claims 1 to 27, produced by the process of any one of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

Aspect 30: A method of fabricating an electromagnetic, EM, device (1000) according to any one of claims 1 to 27, the method comprising any one of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

1. An electromagnetic, EM, device (1000) configured to be operational at a defined center frequency, f, having a free space wavelength, λ, the EM device comprising:
an integrated circuit, IC, chip (2000); and
a DRA subarray (3000) integrally arranged with and disposed on the IC chip (2000);
the DRA subarray (3000) comprising a plurality of DRAs (3100), that can resonate at the same frequency, f, defining a unit cell (3200) having an overall footprint (3300) of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100).

2. The EM device (1000) of claim 1, wherein:
f is equal to or greater than 50 GHz, alternatively equal to or greater than 60 GHz, further alternatively equal to or greater than 77 GHz, further alternatively equal to or greater than 100 GHz, and equal to or less than 1000 GHz.

3. The EM device (1000) claim 1, wherein:
the DRA subarray (3000) is a monolithic construct.

4. The EM device (1000) claim 1, wherein:
each DRA (3100′) of the plurality of DRAs (3100) is a solid, non-hollow, construct.

5. The EM device (1000) of claim 1, wherein:
the DRA subarray (3000) is integrally formed with the IC chip (2000).

6. The EM device (1000) of claim 1, wherein:
the IC chip (2000) comprises a substrate (2100) of dielectric material having a first dielectric constant, Dk, and the plurality of DRAs (3100) comprise a dielectric material having a second Dk.

7. The EM device (1000) of claim 6, wherein:
the second Dk is the same as the first Dk.

8. The EM device (1000) of claim 6, wherein:
the first and second Dk materials each comprise any of: Silicon (Si); Germanium (Ge); Silicon-Germanium (SiGe); Silicon-Carbide (SiC); Gallium Nitride (GaN); or, Gallium Arsenide (GaAs).

9. The EM device (1000) of claim 6, wherein:
the dielectric material of the plurality of DRAs (3100) is the same as the dielectric material of the substrate of the IC chip (2000).

10. The EM device (1000) of claim 1, wherein:
each DRA (3100′) of the plurality of DRAs (3100) has a same 3D shape and size (3150).

11. The EM device (1000) of claim 10, wherein:
the 3D shape (3150) of each DRA (3100′) has a proximal end (3102) proximate the IC chip (2000), and an opposing distal end (3104) at a distance from the IC chip (2000), the 3D shape (3150) tapering inward from the proximal end (3102) to the distal end (3104) to form and define non-DRA space (4000) between each adjacent DRA (3100′) of the plurality of DRAs (3100).

12. The EM device (1000) of claim 11, wherein:
the inwardly tapered 3D shape (3150) has a first effective Dk value at the proximal end (3102), and a second effective Dk value at the distal end (3104) that is less than the first effective Dk value;
wherein the respective effective Dk value is defined by the Dk value associated with incremental and uniform 3D cross sectional slices (3510) in the z-direction of a non-tapered envelope (3500) that bounds both the 3D shape (3150) of the respective DRA (3100′) and the associated portion of non-DRA space (4000) about the respective DRA (3100′);
wherein a thickness h of the 3D cross sectional slices (3510) in the z-direction is equal to or less than 10% of an overall height H of the respective DRA (3100′) in the z-direction.

13. The EM device (1000) of claim 12, wherein:
the first effective Dk value is equal to or greater than 12 and equal to or less than 16, and the second effective Dk value is equal to or greater than 1 and equal to or less than 5.

14. The EM device (1000) of claim 11, wherein:
the inwardly tapered 3D shape (3150) has a taper angle a of equal to or greater than 20-degrees and equal to or less than 35-degrees; alternatively, equal to or greater than 25-degrees and equal to or less than 30-degrees.

15. The EM device (1000) of claim 11, wherein:
the 3D shape (3150) of each DRA (3100′) has overall outside footprint dimensions, a and b, at the proximal end (3102), and an overall height, H, from the proximal end (3102) to the distal end (3104); and
H is greater than a, or H is greater than b; alternatively, H is greater than a, and H is greater than b.

16. The EM device (1000) of claim 15, wherein:
H is equal to or greater than two times a, or H is equal to or greater than two times b;
alternatively, H is equal to or greater than two times a, and H is equal to or greater than two times b.

17. The EM device (1000) of claim 11, wherein:
the 3D shape (3150) of each DRA (3100′) has a faceted surface (3152) that faces another faceted surface (3154) of an adjacent one of the plurality of DRAs (3100).

18. The EM device (1000) of claim 11, wherein:
the DRA subarray (3000) is structurally configured to guide an E-field (5000), when present in the EM device (1000), in the non-DRA space (4000) between each DRA (3100′) of the plurality of DRAs (3100).

19. The EM device (1000) of claim 11, wherein:
a direction of EM radiation (5500), when present in the EM device (1000), is directed from the proximal end (3102) of each DRA (3100′) to the distal end (3104) of each DRA (3100′).

20. The EM device (1000) of claim 1, wherein:
the unit cell (3200) is at least a 2×2 array (3204) of the plurality of DRAs (3100); alternatively, the unit cell (3200) is at least a 3x3 array (3209) of the plurality of DRAs (3100).

21. The EM device (1000) of claim 1, further comprising:
a waveguide (6000) disposed between, and configured to be in EM communication with, the IC chip (2000) and the DRA subarray (3000).

22. The EM device (1000) of claim 21, further comprising:
a ground plane (6500) disposed between, and configured to be in EM communication with, the waveguide (6000) and the DRA subarray (3000), the ground plane (6500) having a plurality of slotted apertures (6502) arranged in a one-to-one correspondence with a respective one of the plurality of DRAs (3100).

23. The EM device (1000) of claim 1, wherein:
the IC chip (2000) is capable of being configured to activate or deactivate certain ones of the plurality of DRAs (3100) in the DRA subarray (3000) so as to effect beam shaping or beam steering within the EM device (1000).

24. The EM device (1000) of claim 1, wherein:
the EM device (1000) forms a unitary DRA-subarray-on-chip construct (1200).

25. The EM device (1000) of claim 21, further comprising:
an encapsulant (1400) disposed encapsulating the IC chip (2000), the waveguide (6000), and DRA subarray (3000).

26. The EM device (1000) of claim 25, wherein:
the encapsulant (1400) comprises a dielectric material.

27. The EM device (1000) of claim 26, wherein:
the dielectric material of the encapsulant (1400) has a Dk value greater than 1 and equal to or less than 5, alternatively equal to or greater than 2 and equal to or less than 4.

28. An electromagnetic, EM, device (1000) according to any one of claim 1, wherein the device is fabricated by the process of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

29. A fabrication of an electromagnetic, EM, device (1000) according to any one of claim 1, produced by the process of the following processes: (1) additive manufacturing; (2) high-resolution 3D printing; (3) ultrahigh-resolution 3D printing; (4) femtosecond laser-induced 3D printing based on two-photon polymerization (TTP); (5) semiconductor device fabrication; (6) laser milling.

30. A method of fabricating an electromagnetic, EM, device (1000) according to claim, the method comprising any one of the following processes: (1) additive manufacturing: (2) high-resolution 3D printing; (3 ) ultrahigh-resolution 3D printing; (4) femtosecond laser-induced 3D printing based on two-photon polymerization (TTP); (5) semiconductor device fabrication; (6) laser milling.
